(19) United States
(12) Patent Application Publication
(10) Pub. No.: US 2026/0058116 A1
(43) Pub. Date: Feb. 26, 2026

(54) ELECTRODE COATING APPARATUS AND ELECTRODE COATING METHOD

(71) Applicant: SAMSUNG SDI CO., LTD., Yongin-si (KR)

(72) Inventor: Hyunsoo KIM, Yongin-si (KR)

(21) Appl. No.: 19/247,512

(22) Filed: Jun. 24, 2025

(30) Foreign Application Priority Data
Aug. 22, 2024 (KR) 10-2024-0112713

(51) Int. Cl. H01M 4/04

(52) U.S. Cl. CPC H01M 4/0433; H01M 4/0404; H01M 4/0409

(57) ABSTRACT

The present disclosure relates to an electrode coating apparatus and an electrode coating method. The electrode coating apparatus may include a modular mold configured to be positioned on an electrode substrate, and a coater configured to dispense an electrode active material slurry on the electrode substrate upon the modular mold being placed on the electrode substrate, thereby forming a coated portion on the electrode substrate in an area defined by the modular mold.

### CROSS REFERENCE TO RELATED APPLICATION

This present application claims priority to and the benefit under 35 U.S.C. § 119(a)-(d) of Korean Patent Application No. 10-2024-0112713, filed on Aug. 22, 2024, in the Korean Intellectual Property Office, the entire disclosure of which is incorporated herein by reference.

### BACKGROUND

### 1. Field

The present disclosure relates to an electrode coating apparatus and an electrode coating method.

### 2. Description of the Related Art

The manufacturing process of secondary batteries typically includes, sequentially, an electrode plate process, an assembly process, and a chemical process. The electrode plate process involves manufacturing a positive electrode and a negative electrode of a secondary battery and can further involve mixing, coating, pressing, and slitting processes. The mixing process involves an electrode active material, which determines the polarity of the secondary battery, mixed with a conductive material, a binder, and a solvent to form a slurry. In the coating process, composites, uniformly mixed during the mixing process, are applied to the surface of an electrode substrate (or a collector) to maintain a predetermined shape. The coating process involves applying the composites to the surface of the electrode substrate then drying the composites.

The process of applying the composite to the electrode substrate may be performed by moving a coater along a predetermined area of application while dispensing the slurry via the coater so that the slurry is applied to the electrode substrate at a constant thickness. This way, the electrode active material can be desirably applied only to the predetermined area and in a predetermined shape; however, such a process is not always practicable. At the interface between an uncoated portion, which is an area of the electrode substrate where the electrode active material is not applied, and a coated portion, which is an area where the electrode active material is applied, the composite may not be applied neatly and therefore, problems, such as dragging, lifting, or sinking, may occur. Accordingly, a deviation in length of the coated portion may occur at the interface, and due to a localized increase or decrease in loading level (L/L), lithium precipitation may happen by the distortion of a so-called N/P ratio between positive and negative electrodes, thereby resulting in a short circuit.

The N/P ratio refers to the capacity per unit area of the negative electrode divided by the capacity per unit area of the positive electrode. Typically, lithium secondary batteries are manufactured so that the negative electrode has a greater loading level than the positive electrode and a larger electrode plate area. This way, lithium ions derived from the positive electrode are prevented from precipitating as lithium metal on the negative electrode, thereby reducing the risk of a short circuit between the positive and negative electrodes. However, in a typical coating process, the capacity of the negative electrode may decrease at the interface between the coated portion and the uncoated portion, thereby causing the N/P ratio to deviate from the above design.

The information disclosed in this Background section is for enhancement of understanding of the background of the present disclosure. The section therefore may contain information that does not constitute related (or prior) art.

### SUMMARY

The present disclosure is directed to providing an electrode coating apparatus and an electrode coating method the address the above-mentioned problems. However, the technical problem to be solved by the present disclosure is not limited to the above-mentioned problems. Other problems not mentioned herein, and aspects and features of the present disclosure that would address such problems, will be clearly understood by those skilled in the art from the description of the present disclosure.

According to embodiments of the present disclosure, an electrode coating apparatus includes a modular mold disposed on an electrode substrate, and a coater configured to dispense an electrode active material slurry on the electrode substrate on which the modular mold is disposed to form a coated portion in an area surrounded by the modular mold.

According to embodiments of the present disclosure, an electrode coating apparatus includes: a modular mold configured to be positioned on an electrode substrate; and a coater configured to dispense an electrode active material slurry on the electrode substrate upon the modular mold being placed on the electrode substrate, thereby forming a coated portion on the electrode substrate in an area defined by the modular mold.

According to some embodiments, the modular mold may include a finishing mold having a bent shape and an uncoated portion mold having an unbent shape.

According to some embodiments, the modular mold may further include a length adjustment mold having an unbent shape, the length adjustment mold being disposed between the finishing mold and the uncoated portion mold.

In an embodiment, the modular mold may further include a length adjustment mold having an unbent shape, wherein the length adjustment mold is positioned between the finishing mold and the uncoated portion mold.

According to some embodiments, the finishing mold may include a vertical bar and a pair of horizontal bars connected to the vertical bar, the horizontal bars being disposed in a longitudinal direction of the electrode substrate toward the uncoated portion mold.

In an embodiment, the finishing mold may include: a vertical section; and a pair of horizontal sections each being in contact with the vertical section and being aligned in a longitudinal direction of the electrode substrate.

According to some embodiments, the uncoated portion mold and the length adjustment mold may each have a straight shape.

In an embodiment, each of the uncoated portion mold and the length adjustment mold may have a straight shape.

According to some embodiments, the modular mold may be configured to be detachably attached to the electrode substrate.

In an embodiment, the modular mold may be configured to be detachably attached onto the electrode substrate.

According to some embodiments, the modular mold may include magnets on ends, the magnets allowing the detachable attachment of the modular mold by magnetic force.

In an embodiment, the modular mold may include magnets allowing the modular mold to be detachably attached onto the electrode substrate by magnetic force.

According to some embodiments, the modular mold may include recesses or protrusions on ends, the recesses or protrusions allowing the detachable attachment of the modular mold by fastening.

In an embodiment, the modular mold may include recesses or protrusions allowing the modular mold to be detachably attached onto the electrode substrate by fastening.

According to some embodiments, the electrode coating apparatus may further include a support portion connected to the modular mold, and the support portion may detachably attach the modular mold onto the electrode substrate.

In an embodiment, the electrode coating apparatus further may include a support portion connected to the modular mold, wherein the support portion is configured to detachably attach the modular mold onto the electrode substrate.

According to some embodiments, the thickness of the modular mold may range from 0.1 mm to 10 mm.

In an embodiment, the modular mold may have a thickness ranging from 0.1 mm to 10 mm.

According to some embodiments, the viscosity of the electrode active material slurry may be 500 Centipoise (cps) or more.

In an embodiment, the electrode active material slurry may have a viscosity of equal to or greater than 500 cps.

According to some embodiments, an amount of the slurry dispensed by the coater may be adjusted so that the loading level of the electrode active material slurry is 100 mg/cm² or less.

In an embodiment, the electrode active material slurry may have a loading level of equal to or less than 100 mg/cm².

According to some embodiments, the electrode substrate may be withdrawn from a roll and transported in a longitudinal direction, and the modular mold and the coater may move up and down with respect to the electrode substrate being transported.

In an embodiment, the electrode substrate may be unwound from a roll and transported in a longitudinal direction, wherein the modular mold and the coater, collectively, are configured to move up and down relative to the electrode substrate being transported.

According to some embodiments, the coater may correspond to one of a roller coater, a spray coater, a blade coater, an extrusion coater, and a die coater.

In an embodiment, the coater may include at least one of a roller coater, a spray coater, a blade coater, an extrusion coater, and a die coater.

According to embodiments of the present disclosure, an electrode coating method includes moving, by a support portion, a modular mold and a coater downwards to be seated on an electrode substrate, coating, by dispensing an electrode active material slurry onto the modular mold by the coater, an area surrounded by the modular mold to form a coated portion in the area surrounded by the modular mold, and moving, by the support portion, the modular mold and the coater upwards.

According to embodiments of the present disclosure, via an electrode coating apparatus including a modular mold, a coater, and a support portion, a method of electrode coating includes: moving the electrode coating apparatus towards an electrode substrate, via the support portion such that the modular mold is detachably attached onto the electrode substrate; coating the electrode substrate by dispensing an electrode active material slurry into the modular mold via the coater, thereby forming a coated portion on the electrode substrate in an area defined by the modular mold; and moving the electrode coating apparatus away from the electrode substrate via the support portion.

According to some embodiments, the electrode coating method may further include assembling the modular mold.

According to some embodiments, the modular mold may include a plurality of modular molds, and the coater may include at least one coater, and a plurality of coated portions may be formed at a same time in the coating.

In an embodiment, the electrode coating apparatus may include a plurality of the modular mold and at least one of the coater, wherein, in the coating step, a plurality of the coated portion is formed on the electrode substrate.

According to some embodiments, the coating may be repeated a plurality of times, the coated portions formed by the plurality of times of the coating being spaced apart from each other.

In an embodiment, the coating step may be repeated multiple times, wherein a plurality of the coated portion is formed on the electrode substrate.

According to some embodiments, the modular mold may include a finishing mold having a bent shape and an uncoated portion mold having an unbent shape.

According to some embodiments, the modular mold may further include a length adjustment mold having an unbent shape, the length adjustment mold being disposed between the finishing mold and the uncoated portion mold.

In an embodiment, the modular mold may further include a length adjustment mold having an unbent shape, wherein the length adjustment mold is positioned between the finishing mold and the uncoated portion mold.

According to various embodiments of the present disclosure, the modular mold may preliminarily limit the area to which the slurry is to be applied so that no dragging, lifting, sinking, or the like of the composite may occur at the interface between the uncoated portion and the coated portion.

According to various embodiments of the present disclosure, a deviation in the length of the coated portion at the interface between the uncoated portion and the coated portion may not occur.

According to various embodiments of the present disclosure, short circuits due to N/P ratio distortion between the positive and negative electrodes and resulting lithium precipitation due to a localized increase or decrease in loading level may not occur.

According to various embodiments of the present disclosure, various composite coating patterns may be easily formed by the process of assembling a modular mold.

According to various embodiments of the present disclosure, a separate operation, such as applying cover tape to the interface between the uncoated portion and the coated portion, after the coating operation may be omitted.

According to various embodiments of the present disclosure, the separate process described above may reduce the area of the coated portion, thereby solving the problem of reduced actual capacity compared to design.

### BRIEF DESCRIPTION OF THE DRAWINGS

The following drawings attached to the present specification illustrate embodiments of the present disclosure, and describe aspects and features of the present disclosure together with the detailed description of the present disclosure. The present disclosure is not limited to embodiments depicted in the drawings:

FIG. 1 is a schematic view showing an electrode coating apparatus according to embodiments of the present disclosure.

FIG. 2 shows portions of an electrode to which a cover tape is attached according to embodiments of the present disclosure.

FIG. 3 shows a modular mold according to embodiments of the present disclosure.

FIG. 4 shows a modular mold according to embodiments of the present disclosure.

FIG. 5 is a schematic view showing an electrode coating apparatus according to embodiments of the present disclosure.

FIG. 6 is a flowchart showing an electrode coating method according to embodiments of the present disclosure.

FIGS. 7 and 8 show electrode coating methods according to embodiments of the present disclosure.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as being consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Numerical ranges disclosed and/or recited herein include all sub-ranges of the same numerical precision subsumed within the recited ranges. For example, a range of “1.0 to 10.0” includes all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein includes all lower numerical limitations subsumed therein, and any minimum numerical limitation recited in this specification includes all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112 (a) and 35 U.S.C. § 132 (a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

Terms used herein describe embodiments of the present disclosure and do not limit the present disclosure.

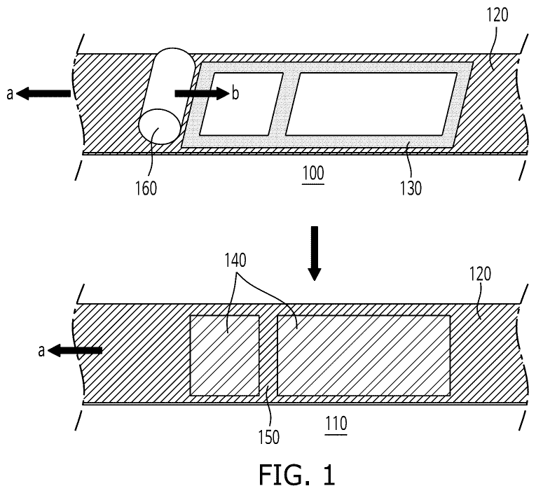

FIG. 1 is a schematic view showing an electrode coating apparatus 100 according to embodiments of the present disclosure. FIG. 1 shows a process of coating patterns of a coated portion 140 and an uncoated portion 150 on at least one surface of an electrode substrate 120 in an electrode coating apparatus 100 and an electrode 110 manufactured thereby. The electrode can be an electrode of a rechargeable lithium secondary battery, but the present disclosure is not limited thereto where, for example, the electrode is an electrode of a primary battery.

The electrode coating apparatus 100 may include a modular mold 130 and a coater 160. As used herein, the “modular mold” refers to a mold that may be disassembled and/or assembled to form various shapes of the electrode 110.

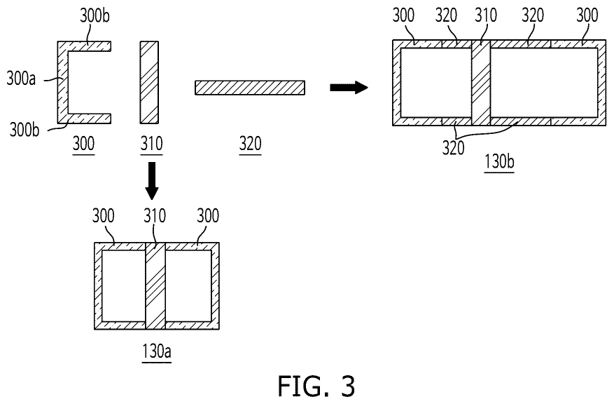

The modular mold 130 may include a frame having a predetermined shape and thickness to define a closed area, as shown in FIG. 1. The modular mold 130 may be assembled to form various closed areas, as described with reference to FIG. 3. The modular mold 130 may be disposed on the electrode substrate 120, and may be detachably attached to the electrode substrate 120.

The coater 160 may dispense an electrode active material slurry onto the electrode substrate 120 on which the modular mold 130 is disposed. After coating, the modular mold 130 may be removed to form a coated portion 140 defined by the area surrounded by the modular mold 130, as in an example of the electrode 110 shown in FIG. 1. Thereafter, the electrode substrate 120 may be transported in the longitudinal direction (i.e., direction a in FIG. 1), and the process described above may be repeated. Accordingly, electrodes having a specific pattern may be mass-produced.

The longitudinal dimension of the coated portion 140 may be controlled in advance by positioning the modular mold 130, and the loading level may be controlled by adjusting the amount of slurry dispensed by the coater 160. Accordingly, the coating may be performed such that the interface between the uncoated portion 150 and the coated portion 140 is clearly delineated.

The electrode substrate 120 may be a positive electrode substrate or a negative electrode substrate. The electrode active material slurry may be a positive electrode active material slurry or a negative electrode active material slurry.

In the case of a positive electrode, the electrode substrate 120 may be a current collector coated with a positive electrode coated portion and in an embodiment, aluminum can be used as the positive electrode substrate. The positive electrode active material slurry may include the positive electrode active material and may further include a binder and/or a coating material.

The electrode substrate 120 may be a current collector coated with a negative electrode coated portion for the negative electrode, and the negative electrode substrate may be selected from, but not limited to, copper foil, nickel foil, stainless steel foil, titanium foil, nickel foam, copper foam, a polymer substrate coated with a conductive metal, and combinations thereof. The negative electrode active material slurry may include the negative electrode active material, and may further include a binder and/or a coating material.

The binder may be configured to bond the electrode active material particles to each other and also to bond the electrode active material to the current collector. The conductive material can be configured to impart conductivity to the electrode, and may be any electronically conductive material that may not contribute to any chemical changes in the battery.

The positive electrode active material may include a compound (lithiated intercalation compound) that is capable of intercalating and/or deintercalating lithium. Specifically, at least one of a composite oxide of lithium and a metal selected from cobalt, manganese, nickel, and combinations thereof, may be used.

The composite oxide may be a lithium transition metal composite oxide. Non-limiting examples of the composite oxide may include lithium nickel-based oxide, lithium cobalt-based oxide, lithium manganese-based oxide, lithium iron phosphate-based compound, cobalt-free nickel-manganese-based oxide, or a combination thereof.

The negative electrode active material may include a material that is capable of reversibly intercalating and deintercalating at least one of a lithium ion, a lithium metal, a lithium metal alloy, a material capable of doping/dedoping lithium, and a transition metal oxide.

The material capable of reversibly intercalating and deintercalating lithium ions may include a carbon-based negative electrode active material, such as crystalline carbon, amorphous carbon or a combination thereof. The crystalline carbon may be graphite such as non-shaped, sheet-shaped, flake-shaped, sphere-shaped, or fiber-shaped natural graphite or artificial graphite. The amorphous carbon may be a soft carbon, a hard carbon, a mesophase pitch carbonization product, calcined coke, and the like.

In an embodiment, the viscosity of the electrode active material slurry of the coated portion 140 may be adjusted to prevent deformation of the shape of the coated portion 140 after removal of the modular mold 130. In an embodiment, the viscosity of the slurry may be adjusted to prevent deformation of the shape of the coated portion 140 during removal of the modular mold 130. In an embodiment, the viscosity of the slurry may be 500 Centipoise (cps) or greater.

In an embodiment, the amount of slurry dispensed by the coater 160 may be adjusted such that the loading level of the electrode active material slurry is 100 mg/cm² or less. By adjusting the loading level of the slurry in this manner, deformation of the coated portion 140 may not occur during removal of the modular mold 130.

The coater 160 may be one of a roller coater, a spray coater, a blade coater, an extrusion coater, and a die coater.

Referring to FIG. 1, where the coater 160 is shown as a roller coater, the roller coater may move on the modular mold 130 from a first longitudinal end of the electrode substrate 120 to a second longitudinal end of the modular mold 130 to dispense the slurry and, at the same time, press/shape/spread/smooth the slurry. In an embodiment, the process may proceed as the roller coater moves in direction b. While the roller coater may cause some of the slurry to spill over the top of the modular mold 130, the modular mold 130 may be periodically replaced along with the excess slurry. During application, the slurry does not penetrate between the modular mold 130 and the electrode substrate 120. Accordingly, the coated portion 140 may be formed in the area surrounded by the modular mold 130, and the slurry may be neatly applied at the interface between the uncoated portion 150 and the coated portion 140 so that no dragging, lifting, sinking, or the like, may occur.

Although not shown in FIG. 1, the coater 160 can be a blade coater, such as a doctor blade, which may scrape away excess slurry from the dispensed slurry to uniformly form the coated portion 140. Accordingly, the excess slurry may be moved into the modular mold 130. The doctor blade coater may move from a first end of the area surrounded by the modular mold in the longitudinal direction to a second end of the area forming the coated portion 140. In an embodiment, referring to FIG. 1, the doctor blade coater may move in a first direction (i.e., the direction b) then move in the opposite direction. This process may be repeated to achieve a uniform coating.

Although not shown in FIG. 1, the coater 160 can be a spray coater, where contactless coating may be performed using a spray nozzle or gun to dispense the slurry at high speed onto the electrode substrate 120 on which the modular mold 130 is disposed, and depositing the slurry by momentum and gravity onto the electrode substrate 120 in the area surrounded by the modular mold 130. While the slurry may be sprayed into the modular mold 130, the modular mold 130 may be periodically replaced along with the excess slurry. Because the slurry is sprayed, the slurry does not penetrate between the modular mold 130 and the electrode substrate 120.

Although not shown in FIG. 1, the coater 160 can be a die coater, where a slot die or a shutter die may dispense the slurry from the top of the electrode substrate 120 as the electrode substrate 120 is being transported in a horizontal direction. By dispensing the slurry in such a direction, the coated portion 140 may be smoothly formed in the area surrounded by the modular mold 130 disposed on the electrode substrate 120. Similarly, the slurry dispensed from the slot or shutter may be applied to the modular mold 130, and may be partially removed in the process of removing the modular mold 130, or the accumulated slurry residue may be removed by periodic replacement of the modular mold 130.

Advantageously, the modular mold 130 may be readily and periodically replaced using any coater 160, thereby allowing the coating process to be performed using various types of coaters 160.

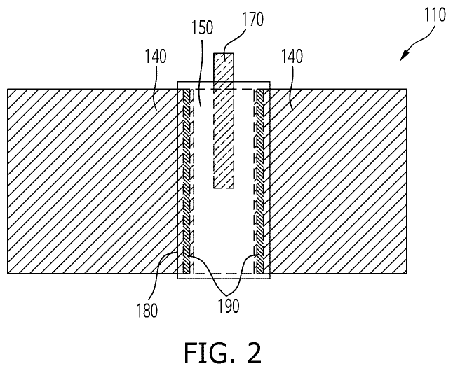

FIG. 2 shows portions of an electrode 110 to which a cover tape 180 is attached according to embodiments of the disclosure. FIG. 2 shows the attachment position of the cover tape 180 to address problems occurring at the interface 190 between the uncoated portion 150 and the coated portion 140.

An electrode tab 170 may be electrically connected, for example, by welding, to the uncoated portion 150, which is an area where the electrode active material is not applied. The electrode tab 170 may be a path for current flow between the electrode 110 and a separate current collector of the secondary battery. The cover tape 180 may cover the entire area of the uncoated portion 150, an area of the electrode tab 170 connected to the uncoated portion 150, and a portion of the coated portion 140. In an embodiment, the cover tape 180 may be attached to cover at least the interface 190 between the uncoated portion 150 and the coated portion 140. As a result, compression of the cover tape 180 prevents any dragging, lifting, sinking, or the like, of the composite at the interface 190 during coating. The cover tape 180 may be formed from an insulating material. In an embodiment, the cover tape 180 may be formed from a polymer, such as polypropylene (PP), polyethylene terephthalate (PET), or polyimide (PI). Because at least one surface of the cover tape 180 is adhesive, the cover tape 180 may be attached to and mounted together with the electrode 110 at the interface.

In an embodiment, the cover tape 180 may be attached to an area of the coated portion 140 reducing a portion of the area of the coated portion 140. The reduced area of the coated portion 140 may be partially unable to function as an electrode active material in the battery, thereby resulting in reduced actual battery capacity relative to the initial design. However, this way, dragging, lifting, or sinking, that may occur during the electrode coating process can be prevented. Still, a separate application of the cover tape 180 may be required after the coating process.

FIG. 3 shows modular molds according to embodiments of the present disclosure.

In an embodiment, the modular mold (e.g., 130 in FIG. 1) may include a finishing mold 300 having a bent shape and an uncoated portion mold 310 having an unbent shape. The finishing mold 300 may include a leading end (e.g., left hand side) mold and a trailing end (e.g., right hand side) mold of the modular mold. The leading end mold may be a mold that defines a portion on the electrode substrate (e.g., 120 in FIG. 1) at which coating of the coated portion (e.g., 140 in FIG. 1) begins, and the trailing end mold may be a mold that defines a portion on the electrode substrate at which coating of the coated portion (e.g., 140 in FIG. 1) ends. In an embodiment, the coater may begin dispensing the slurry at a position near the leading end mold. The uncoated portion mold 310 may be a mold that defines an area where the uncoated portion of the electrode (e.g., 150 in FIG. 2) is to be formed.

Referring to modular mold assembly processes 130a and 130b in FIG. 3, the finishing mold 300 may include a vertical section 300a and a pair of horizontal sections 300b connected to the vertical section 300a, in which the horizontal sections 300b may be disposed in the longitudinal direction of the electrode substrate toward the uncoated portion mold 310. Here, the horizontal sections 300b of the finishing mold 300 may be arranged so that the distal ends (i.e., the ends of the horizontal sections 300b that are not in contact with the vertical section 300a) may be in contact with the ends of the uncoated portion mold 310 in the longitudinal direction. The finishing mold 300 may have a bent shape by connecting portions of the vertical section 300a and the horizontal sections 300b.

The shape and size of the uncoated portion mold 310 may be determined based on the shape and size of the uncoated portion, which is the area that is not coated with the electrode composite allowing the electrode tab (e.g., 170 in FIG. 2) to be electrically connected to the electrode substrate. Accordingly, the shape and size of the uncoated portion mold 310 may vary depending on the type of the battery.

In an embodiment, the modular mold 130a, 130b may further include length adjustment molds 320 having a unbent shape, and the length adjustment molds 320 may be disposed between the finishing mold 300 and the uncoated portion mold 310. The length adjustment molds 320 may be disposed between the leading end mold and the uncoated portion mold 310 and/or between the trailing end mold and the uncoated portion mold 310. The length adjustment molds 320 may be configured to adjust the length of the coated composite in the longitudinal direction of the electrode substrate.

Referring to the first modular mold assembly process 130b, the length adjustment mold 320 disposed between the leading end mold and the uncoated portion mold 310 may have a different length than the length adjustment mold 320 disposed between the trailing end mold and the uncoated portion mold 310. However, this is not intended to be limiting, where the length adjustment molds 320 may have substantially the same length. The length adjustment molds 320 may have different lengths depending on the design of the positions of the electrode tabs or lead tabs that may be withdrawn in the electrode assembly. Referring to the second modular mold assembly process 130a, no length adjustment molds 320 may be disposed.

In an embodiment, the uncoated portion mold 310 and the length adjustment mold 320 may have a unbent shape, in contract with the shape of the finishing mold 300. In an embodiment, the uncoated portion mold 310 and the length adjustment mold 320 may have a straight shape. Each of the uncoated portion mold 310 and the length adjustment mold 320 may be designed to have different lengths and widths depending on the type of the battery.

The length of the coated portion may be adjusted by further attaching or removing the length adjustment mold 320. The width of the coated portion may be determined according to the length of the modular mold of the portion corresponding to the lateral direction of the electrode substrate. In an embodiment, the length of the vertical section 300a of the modular mold may be longer than the length of the horizontal section 300b.

In an embodiment, the width of the horizontal sections 300b in the finishing mold 300 may be substantially the same width of the length adjustment mold 320. Accordingly, the distal end of the horizontal sections 300b of the finishing mold 300 and the end of the length adjustment mold 320 are flushly in contact with each other. That is, the ends of the coated portion coated by the electrode coating apparatus become sufficiently smooth for winding of electrodes or for manufacturing of electrode assemblies formed by stacking a plurality of electrodes.

In an embodiment, the thickness of the modular mold may be designed to be independent of the thickness of the composite coated on the electrode substrate. The thickness or loading level of the composite coated may be controlled by the dispense volume of the slurry. The thickness of the modular mold may not be determined based on the thickness of the designed composite. In an embodiment, the thickness of the modular mold and the thickness of the coated composite may be different or substantially the same. In an embodiment, the thickness of the modular mold may range from 0.1 mm to 10 mm. This way, sufficient surface tension may be generated in the applied slurry so that sinking is prevented at the interface between the uncoated portion and the coated portion, and localized increase or decrease in the loading level is prevented at the interface. In an embodiment, the thickness of the modular mold 130 may be designed based on the thickness of the composite coated on the electrode substrate. In an embodiment, the coater 160 corresponds to a blade coater, and the thickness of the modular mold 130 may correspond to the thickness of the composite coated on the electrode substrate.

In an embodiment, the thicknesses of the finishing mold 300, the uncoated portion mold 310, and the length adjustment mold 320 may be substantially the same. Accordingly, the top surface of the modular mold is smooth and flush. This way, when the coating process is carried out using a coater in contact with the modular mold, such as a roller coater or a blade coater, the coater may operate smoothly and the slurry may be applied uniformly to the area surrounded by the modular mold.

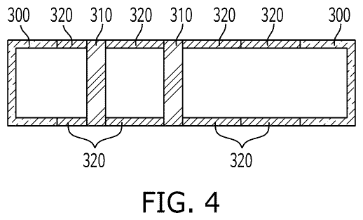

FIG. 4 shows a modular mold according to embodiments of the present disclosure. Referring to FIG. 4, a plurality of uncoated portion molds 310 may be disposed between the leading end mold and the trailing end mold. A plurality of length adjustment molds 320 may be disposed between the uncoated portion molds 310 and the finishing mold 300.

In an embodiment, two length adjustment molds 320, in sequence, may be disposed between the trailing end mold and the uncoated portion mold 310. This way, a composite pattern having a larger area may be formed compared to the composite of the electrode plates formed from the modular mold shown in FIG. 3.

The modular mold may be detachably attached to the electrode substrate to form various shapes and/or patterns. Any method of attaching and detaching the modular mold may be used as long as the modular mold may be assembled thereby. However, such a method may be used to the extent that the method does not leave a residue on the electrode substrate or does not contribute to cracking. In an embodiment, the modular mold, at the ends, may include magnets allowing the mold to be magnetically assembled or disassembled. In an embodiment, the magnets may be provided on the entire area of the modular mold or on the ends of the modular mold. This way, the finishing mold 300, the uncoated portion mold 310, and the length adjustment mold 320 of the modular mold may be connected to each other.

In an embodiment, the modular mold, at the ends, may include grooves or protrusions allowing the mold to be detachably attached to the electrode substrate. Corresponding to the groove or protrusion on the ends of the first mold of the modular mold, a protrusion or a groove may be provided on the end of the second mold of the modular mold. In an embodiment, each of the finishing mold 300, the uncoated portion mold 310, and the length adjustment mold 320 of the modular mold may include a fastener. The fasteners may have a corresponding shape to the recesses or protrusions. The use of the fasteners may allow the finishing mold 300, the uncoated portion mold 310, and the length adjustment mold 320 to be fastened together and then unfastened to individual molds. In an embodiment, the fasteners of the finishing mold 300 correspond to recesses, and the fasteners of the length adjustment mold 320 configured to engage with the finishing mold 300 may correspond to protrusions. In an embodiment, the fasteners of the finishing mold 300, the uncoated portion mold 310, and the length adjustment mold 320 may include magnets. In an embodiment, the fasteners of the finishing mold 300 and the fasteners of the length adjustment mold 320 configured to engage with the finishing mold 300 may include magnets, such that the finishing mold 300 and the length adjustment mold 320 may be engaged with each other by magnetic force.

In an embodiment, the modular mold may be designed such that the modular mold attached to the electrode substrate does not move when the slurry is dispensed onto the electrode substrate or when pressure is applied to the electrode substrate by the coater.

In an embodiment, the modular mold may include at least one of plastic, stainless steel, or Teflon (polytetrafluoroethylene).

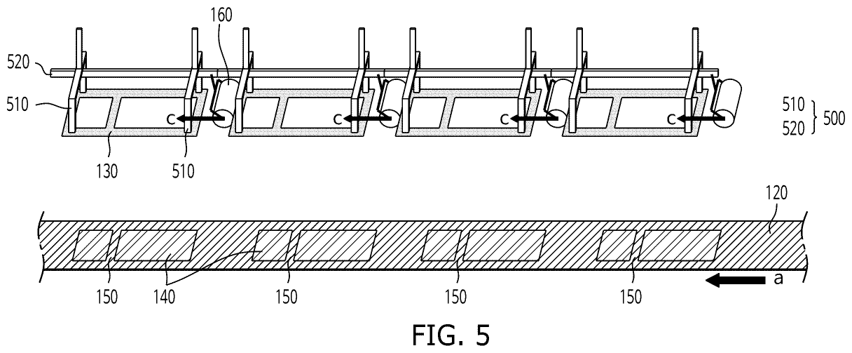

FIG. 5 is a schematic view showing an electrode coating apparatus according to embodiments of the present disclosure.

The electrode coating apparatus may include: a modular mold 130 disposed on an electrode substrate 120; a coater 160 configured to dispense an electrode active material slurry onto the electrode substrate 120 on which the modular mold 130 is disposed, forming a pattern of a coated portion 140; and a support portion 500 connected to the modular mold 130.

The support portion 500 may be connected to the modular mold 130, and may be configured to detachably attach the modular mold 130 to the electrode substrate 120. In an embodiment, the support portion 500 may include columns 510 and a bridge 520 connected to the top surface of the modular mold 130. The columns 510 may be connected to a plurality of molds of the modular mold 130. The bridge 520 may be in contact with the columns 510. In an embodiment, as shown in FIG. 5, two of the four columns 510 may be connected to a leading end mold and the remaining two of the four columns 510 may be connected to a trailing end mold. All four columns 510 may be connected to the bridge 520. However, this is not intended to be limiting, and the columns 510 may be connected to at least one of a finishing mold, a length adjustment mold, and an uncoated portion mold.

In an embodiment, the support portion 500 may connect the finishing mold (e.g., 300 in FIGS. 3 and 4), the uncoated portion mold (e.g., 310 in FIGS. 3 and 4), and the length adjustment mold (e.g., 320 in FIGS. 3 and 4) of the modular mold 130 to each other. The support portion 500 may be configured to prevent the respective molds of the modular mold 130 from being separated during transport onto the electrode substrate 120.

The electrode substrate 120 may be unwound from a first roll and transported in a longitudinal direction (e.g., direction a) to be wound onto a second roll. The modular mold 130 and the coater 160 may move up and down relative to the electrode substrate 120 being transported. The bridge 520 of the support portion 500 may be connected to a separate controller that adjusts the up and down movement continuously coating the longitudinally transported electrode substrate 120 with the coated portion 140. The controller may adjust the rate of the up and down movement of the support portion 500 in response to the feed rate value of the electrode substrate 120. Accordingly, a particular pattern of the coated portion 140 may be continuously mass-produced on the electrode substrate 120. In addition, other types of patterns of the coated portion 140 may be mass-produced by an assembly process of connecting and disconnecting the modular mold 130.

The up and down movement may indicate that the bridges are moved downwards until the modular mold 130 is detachably attached onto the electrode substrate 120 and then moved upwards after the coating is completed. In addition, the controller may detect whether the coating is completed based on the resultant value of the distance traveled by the coater 160 and may adjust the up and down movement of the bridges accordingly.

The coating operation described above may be repeated multiple times. A pattern of the coated portion 140 and the uncoated portion 150 including the coated portion 140 and the uncoated portion 150 formed by a plurality of coating operations may be repeatedly formed on the electrode substrate 120.

In an embodiment, the electrode coating apparatus may include multiple modular molds 130 and coaters 160, and the support portion 500 may connect the modular molds 130 and coaters 160. In an embodiment, the columns 510 connected to the modular mold 130 may be connected to a single bridge 520. The single bridge 520 may move up and down relative to the electrode substrate 120 being transported, thereby allowing a plurality of patterns of the coated portion 140 and the uncoated portion 150 to be formed simultaneously. The patterns of the coated portion 140 and the uncoated portion 150 may be formed on the electrode substrate 120 spaced apart by a predetermined length.

In an embodiment, continuous coating may be performed at the same time using multiple coating apparatuses including one or more modular molds 130. In an embodiment, a plurality of coating apparatuses each having a single modular mold 130 connected to a single bridge 520 may be provided to perform a continuous coating process. In an embodiment, a plurality of coating apparatuses each having a plurality of modular molds 130 connected to a single bridge 520 may be provided to perform a continuous coating process. Advantageously, the productivity of the electrode coating process may be significantly improved.

In an embodiment, the coater 160 may be connected to the bridge 520 of the support portion 500. In an embodiment, as shown in FIG. 5, the roller coater 160 may perform a coating process while being moved from the trailing end mold to the leading end mold of the modular mold 130 (e.g., direction c). In an embodiment, the coating process can be performed in the opposite direction.

In an embodiment, the coating apparatus may include a coater 160 for each modular mold 130, and, as shown in FIG. 5, multiple coating apparatuses can be used, each including a coater 160 and a modular mold 130. In an embodiment (not shown), a single coater 160 and a plurality of modular molds 130 can be used. The single coater 160 may move along the bridge 520 and coat the electrode substrate 120 while, at the same time, the modular molds 130 are placed. In addition, the coating may be performed with the slurry dispensed by the single coater 160, improving slurry use efficiency.

Although not shown in FIG. 5, the coater can be a spray coater, where a plate may be provided on the bridge portion and a plurality of spray nozzles may be provided on the bottom surface of the plate. As shown in FIG. 5, where a plurality of coaters 160 and a plurality of modular molds 130 are provided, slurry may be sprayed through the nozzles after the modular molds 130 are deposited on the electrode substrate 120. Accordingly, a plurality of patterns of the coated portion 140 and the uncoated portion 150 may be formed on the electrode substrate 120 at the same time.

In an embodiment, the modular mold 130 and the coater 160 are separate components or are consolidated to be a single component. In an embodiment, the modular mold 130 and the coater 160 are separate components, in which after the modular mold 130 is detachably attached onto the electrode substrate 120, the coater 160 is operated by detecting the seating of the modular mold 130.

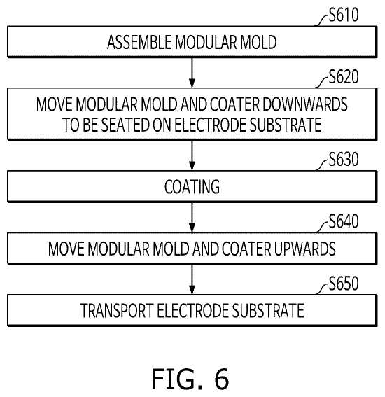

FIG. 6 is a flowchart showing an electrode coating method according to embodiments of the present disclosure. In an embodiment, the electrode coating method may include: a step S620 of moving a modular mold and a coater downwards using a support portion to be detachably attached onto an electrode substrate; a coating step S630 of dispensing an electrode active material slurry into the modular mold by the coater to form a coated portion in an area surrounded by the modular mold; and a step S640 of moving the modular mold and the coater upwards using the support portion.

The method of coating the electrode according to embodiments may further include a step S610 of assembling the modular mold prior to the step S620 of downwardly moving and seating the modular mold. The step S610 of assembling the modular mold allows various uncoated portion-coated portion patterns formed depending on the battery type.

In an embodiment, the electrode coating method may further include a step S650 of transporting the electrode substrate after the step S640 of moving the modular mold and coater upwards.

The flowchart of FIG. 6 and the corresponding description are illustrative of the present disclosure, but the scope of the present disclosure is not limited thereto. For example, one or more of the operations/steps in the above flowchart and description may be added, altered, and/or deleted, the order of one or more of the operations may be changed, and one or more of the operations may be performed simultaneously.

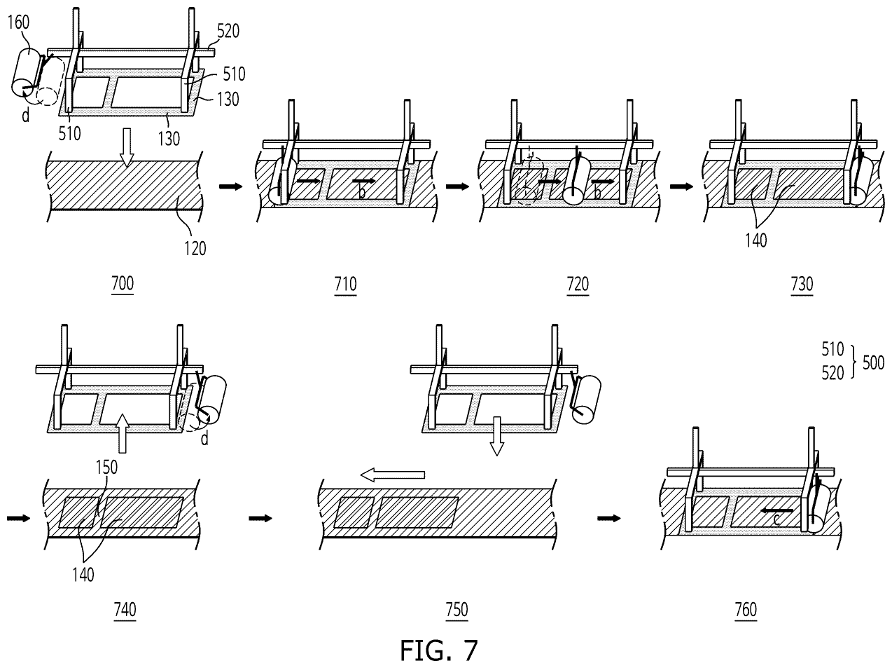

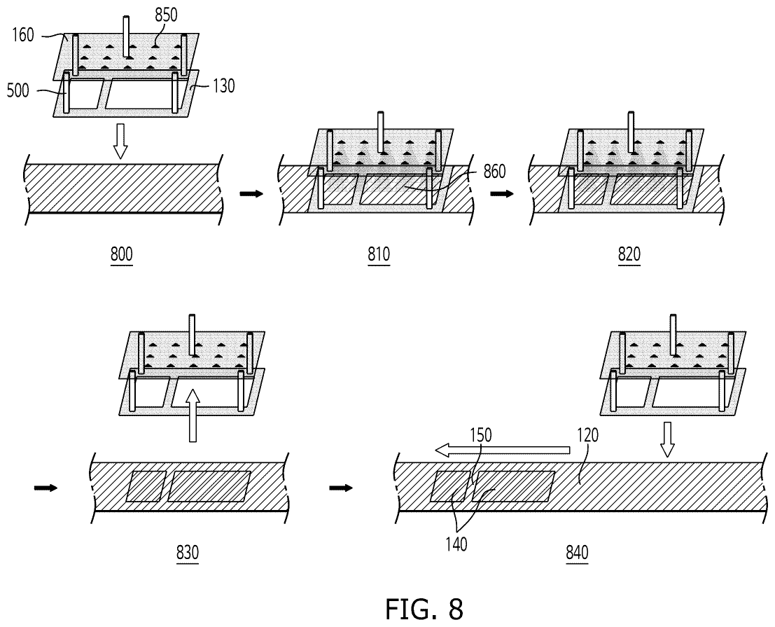

FIGS. 7 and 8 show electrode coating methods according to embodiments of the present disclosure. FIG. 7 shows a process of electrode coating where the coater 160 is a roller coater, and FIG. 8 shows a process of electrode coating where the coater 160 is a spray coater.

Referring to FIG. 7, the coating process may begin with an operation 700 of moving the modular mold 130 connected to the columns 510 of the support portion 500 downwards onto the electrode substrate 120. In an embodiment, the roller coater 160 may be hangingly coupled to the bridge 520. in an embodiment, the roller coater 160 may be coupled to the bridge 520 by a separate thin and elongated connecting member connected to the roller coater 160.

To prevent loss of slurry, the roller coater 160 may be configured to contact the modular mold 130 after the modular mold 130 is detachably attached onto the electrode substrate 120. In an embodiment, as shown in FIG. 7, the roller coater 160 may be fixed with no contact with the modular mold 130 until the modular mold 130 is detachably attached onto the electrode substrate 120. One end of the roller coater 160 may be rotatably fixed and the roller coater 160 can be rotated in a direction (i.e., a direction d) away from the modular mold 130.

Thereafter, an operation 710 may be performed moving the modular mold 130 downwards to be detachably attached onto the electrode substrate 120 as the support portion 500 moves downwards. At the same time, the roller coater 160 may rotate in a direction toward the modular mold 130 to be in a coating-ready state. As the modular mold 130 is detachably attached onto the electrode substrate 120 (e.g., direction b), the roller coater may be adjusted to contact, for example, a leading end mold. As the roller coater moves past the entire top surface of the modular mold 130 (e.g., in direction b), the coating operation 720 may be performed dispensing and pressing the slurry.

After an operation 730 of completing coating a coated portion 140 in the area surrounded by the modular mold 130, the roller coater 160 may be returned in a coater adjustment direction (e.g., direction d). In an embodiment, the roller coater 160 may be rotated in a direction (e.g., direction d) away from the modular mold 130 and be fixed. At the same time, an operation 740 may be performed moving the modular mold 130 upwards by the support portions 500. Slurry loss can be prevented by returning the roller coater 160.

Thereafter, the electrode substrate 120 may be transported in the longitudinal direction of the electrode substrate 120 so that the uncoated electrode substrate 120 may be disposed on the bottom side of the modular mold 130. At the same time, an operation 750 may be preformed moving the modular mold 130 downwards by the support portion 500.

Thereafter, an operation 760 may be performed moving the modular mold 130 downwards so that the roller coater 160 contacts the trailing end mold, which may be substantially similar as described in the previous operations. Here, the direction in which the roller coater moves may be a (e.g., direction c) opposite to a direction (e.g., direction b) in the coating operation 720.

Referring to FIG. 8, in an embodiment, the coater 160 may be a spray coater 160, where a plurality of nozzles 850 configured to spray slurry are provided on the bottom surface of a plate, and the plate may function as a bridge (e.g., 520 in FIG. 5). The length between the spray coater 160 and the modular mold 130 may be, for example, from 1 mm to 1,000 mm. This length may specifically refer to the length between the bottom surface of the nozzle 850 and the modular mold 130.

The coating process may begin with an operation 800 of moving the modular mold 130 downwards, where the slurry may or may not be sprayed. Thereafter, the modular mold 130 may be detachably attached onto the electrode substrate 120. Thereafter, an operation 810 may be performed spraying a coating solution spray 860 through the nozzle 850 while detecting the attachment of the modular mold 130. In addition, a coating operation 820 may be performed forming the coated portion 140 by spraying and applying the coating solution at a high speed to the area surrounded by the modular mold 130.

The coating solution spray 860 may be in the form of slurry droplets. Thereafter, an operation 830 may be performed moving the modular mold 130 upwards, where the spraying of the coating solution spray 860 through the nozzle 850 may be stopped.

Thereafter, an operation 840 may be performed transporting the electrode substrate 120 in the longitudinal direction, so that a fresh electrode substrate 120 is positioned below the modular mold 130. The modular mold 130 may be moved downwards and substantially similar operations may be performed repeatedly, thereby enabling continuous mass production of electrodes.

Although the present disclosure has been described with reference to embodiments and drawings illustrating aspects thereof, the present disclosure is not limited thereto. Various modifications and variations can be made by a person skilled in the art to which the present disclosure belongs within the scope of the technical spirit of the present disclosure.

### DESCRIPTION OF NOTABLE REFERENCE SYMBOLS

100: electrode coating apparatus
110: electrode
120: electrode substrate
130: modular mold
140: coated portion
150: uncoated portion
160: coater
170: electrode tab
180: cover tape
190: interface
300: finishing mold
310: uncoated portion mold
320: length adjustment mold
500: support portion
850: nozzle
860: coating solution spray
a: direction of transport of electrode substrate
b, c: direction of movement of coater
d: direction of adjustment of coater

What is claimed is:

1. An electrode coating apparatus, comprising:
a modular mold configured to be positioned on an electrode substrate; and
a coater configured to dispense an electrode active material slurry on the electrode substrate upon the modular mold being placed on the electrode substrate, thereby forming a coated portion on the electrode substrate in an area defined by the modular mold.

2. The electrode coating apparatus as claimed in claim 1, wherein the modular mold comprises: a finishing mold having a bent shape; and an uncoated portion mold having an unbent shape.

3. The electrode coating apparatus as claimed in claim 2, wherein the modular mold further comprises a length adjustment mold having an unbent shape,
wherein the length adjustment mold is positioned between the finishing mold and the uncoated portion mold.

4. The electrode coating apparatus as claimed in claim 2, wherein the finishing mold comprises: a vertical section; and a pair of horizontal sections each being in contact with the vertical section and being aligned in a longitudinal direction of the electrode substrate.

5. The electrode coating apparatus as claimed in claim 3, wherein each of the uncoated portion mold and the length adjustment mold have a straight shape.

6. The electrode coating apparatus as claimed in claim 1, wherein the modular mold is configured to be detachably attached onto the electrode substrate.

7. The electrode coating apparatus as claimed in claim 6, wherein the modular mold comprises magnets allowing the modular mold to be detachably attached onto the electrode substrate by magnetic force.

8. The electrode coating apparatus as claimed in claim 1, wherein the modular mold comprises recesses or protrusions allowing the modular mold to be detachably attached onto the electrode substrate by fastening.

9. The electrode coating apparatus as claimed in claim 1, further comprising a support portion connected to the modular mold,
wherein the support portion is configured to detachably attach the modular mold onto the electrode substrate.

10. The electrode coating apparatus as claimed in claim 1, wherein the modular mold has a thickness ranging from 0.1 mm to 10 mm.

11. The electrode coating apparatus as claimed in claim 1, wherein the electrode active material slurry has a viscosity of equal to or greater than 500 cps.

12. The electrode coating apparatus as claimed in claim 1, wherein the electrode active material slurry has a loading level of equal to or less than 100 mg/cm².

13. The electrode coating apparatus as claimed in claim 1, wherein the electrode substrate is unwound from a roll and transported in a longitudinal direction, and
wherein the modular mold and the coater, collectively, are configured to move up and down relative to the electrode substrate being transported.

14. The electrode coating apparatus as claimed in claim 1, wherein the coater comprises at least one of a roller coater, a spray coater, a blade coater, an extrusion coater, and a die coater.

15. A method of electrode coating via an electrode coating apparatus comprising a modular mold, a coater, and a support portion, the method comprising:
moving the electrode coating apparatus towards an electrode substrate, via the support portion such that the modular mold is detachably attached onto the electrode substrate;
coating the electrode substrate by dispensing an electrode active material slurry into the modular mold via the coater, thereby forming a coated portion on the electrode substrate in an area defined by the modular mold; and
moving the electrode coating apparatus away from the electrode substrate via the support portion.

16. The method as claimed in claim 15, further comprising assembling the modular mold.

17. The method as claimed in claim 15, wherein the electrode coating apparatus comprises a plurality of the modular mold and at least one of the coater, and
wherein, in the coating step, a plurality of the coated portion is formed on the electrode substrate.

18. The electrode coating method as claimed in claim 15, wherein the coating step is repeated multiple times, and
wherein a plurality of the coated portion is formed on the electrode substrate.

19. The electrode coating method as claimed in claim 15, wherein the modular mold comprises: a finishing mold having a bent shape; and an uncoated portion mold having an unbent shape.

20. The electrode coating method as claimed in claim 19, wherein the modular mold further comprises a length adjustment mold having an unbent shape,
wherein the length adjustment mold is positioned between the finishing mold and the uncoated portion mold.
